(19) United States
(12) Patent Application Publication
(10) Pub. No.: US 2026/0264030 A1
(43) Pub. Date: Sep. 10, 2026

(54) MIXING APPARATUS

(71) Applicant: SK ON CO., LTD., Seoul (KR)

(72) Inventor: Hyung Min GO, Daejeon (KR)

(21) Appl. No.: 19/558,449

(22) Filed: Mar. 6, 2026

(30) Foreign Application Priority Data
Mar. 7, 2025 (KR) 10-2025-0029739

(51) Int. Cl. B01F 31/80; B01F 23/50; B01F 23/53; B01F 27/42; B01F 27/808; B01F 27/906; B01F 35/213; B01F 35/221; B01F 35/222; B01F 35/90

(52) U.S. Cl. CPC B01F 31/83; B01F 23/53; B01F 23/551; B01F 27/421; B01F 27/808; B01F 27/906; B01F 35/213; B01F 35/2213; B01F 35/222; B01F 35/90; B01F 2035/98

(57) ABSTRACT

The present disclosure relates to a mixing apparatus including an accommodation vessel including an inlet on one surface thereof and having a mixing space configured to accommodate a particle-mixed liquid through the inlet, a rotatable stirring part disposed in the mixing space through the inlet to allow the particle-mixed liquid to flow within the accommodation vessel, a stirring driving part configured to rotate the stirring part, and an ultrasonic generating part configured to allow the particle-mixed liquid to flow.

### CROSS-REFERENCE TO RELATED PATENT APPLICATION

The present application claims priority under 35 U.S.C. § 119(a) to Korean patent application number 10-2025-0029739 filed on Mar. 7, 2025, in the Ministry of Intellectual Property, the entire disclosure of which is incorporated by reference herein.

### BACKGROUND OF THE INVENTION

### 1. Field

The present disclosure relates to a mixing apparatus. More particularly, the present disclosure relates to a mixing apparatus for improving a manufacturing efficiency of battery cells.

### 2. Description of the Related Art

A secondary battery includes an electrode assembly having a positive electrode, a negative electrode, and a separator separating the positive electrode and the negative electrode from each other.

In general, the positive electrode includes an NCM (nickel, cobalt, manganese)-based positive electrode active material or an LFP (Lithium, Ferrum, Phosphoric Acid)-based positive electrode active material, and the negative electrode includes a negative electrode active material such as graphite or a silicon composite.

The positive electrode and the negative electrode may be prepared by respectively coating electrode plates with the positive electrode active material and the negative electrode active material in the form of a slurry.

To this end, how quickly and uniformly the positive electrode active material and the negative electrode active material may be produced in a large volume (e.g., 2000 L (liters) or more) is one of the important factors that may determine a manufacturing efficiency of a secondary battery.

However, since conventional mixing devices utilize only mechanical stirring, there have been problems such as long mixing times at large volumes and excessive energy consumption caused thereby.

### SUMMARY OF THE INVENTION

An object of the present disclosure is to improve a manufacturing efficiency of battery cells.

Another object of the present disclosure is to uniformly mix a positive electrode active material or a negative electrode active material in a large capacity mixing apparatus within a short time.

Another object of the present disclosure is to uniformly mix a positive electrode active material or a negative electrode active material using ultrasonic waves.

Another object of the present disclosure is to utilize ultrasonic waves while preventing an excessive increase in temperature of a liquid active material accommodated in a mixing apparatus.

Another object of the present disclosure is to prevent materials mixed in a mixing apparatus from being damaged during a mixing process.

Another object of the present disclosure is to minimize inclusion of air bubbles in a positive electrode active material or a negative electrode active material while utilizing ultrasonic waves.

The present disclosure may be widely applied in the field of green technology, such as electric vehicles, battery charging stations, energy storage systems (ESS), and other green technologies that utilize batteries, such as photovoltaics and wind power.

In addition, the present disclosure may be used in eco-friendly mobility, including electric vehicles and hybrid vehicles to prevent climate change by curbing air pollution and greenhouse gas emissions.

Embodiments of the present disclosure provide a mixing apparatus including: an accommodation vessel including an inlet on one surface thereof and having a mixing space configured to accommodate a particle-mixed liquid through the inlet; a rotatable stirring part disposed in the mixing space through the inlet to allow the particle-mixed liquid to flow within the accommodation vessel; a stirring driving part configured to rotate the stirring part; a rotating part spaced apart from the stirring part and rotated with the stirring part to rotate the particle-mixed liquid within the accommodation vessel; a rotation driving part configured to rotate the rotating part; and an ultrasonic generating part disposed in at least one of the rotating part, the stirring part, or the accommodation vessel to generate ultrasonic waves toward the mixing space.

In an embodiment, the ultrasonic generation part may generate pulsed ultrasonic waves.

In an embodiment, the ultrasonic generating part may be provided in plurality, the plurality of ultrasonic generating parts may be disposed at different heights based on a lowest limit of the accommodation vessel, and the plurality of ultrasonic generating parts may have respective upper and lower limits of different amplitudes or different frequencies depending on heights at which the plurality of ultrasonic generating parts are disposed.

In an embodiment, the plurality of ultrasonic generating parts may include: a first ultrasonic generating part disposed in a first region from the lowest limit of the accommodation vessel to a preset first height; a second ultrasonic generating part disposed in a second region from the first height to a preset second height; and a third ultrasonic generator disposed in a third region from the second height to the inlet. Here, amplitudes or frequencies of respective ultrasonic waves generated by the first ultrasonic generating part, the second ultrasonic generating part, and the third ultrasonic generating part may have different upper and lower limits.

In an embodiment, the ultrasonic generating part may generate the ultrasonic waves intermittently when the stirring part is rotated.

In an embodiment, the mixing apparatus may further include a temperature sensor configured to measure a temperature of the particle-mixed liquid.

In an embodiment, the ultrasonic generating part may repeatedly generate and stop generating the ultrasonic waves based on a temperature of the particle-mixed liquid, which is measured by the temperature sensor.

In an embodiment, the ultrasonic generating part may stop generating the ultrasonic waves when the temperature of the particle-mixed liquid exceeds a preset allowable temperature.

In an embodiment, the rotational speed and rotational time of the stirring part may be variable based on a temperature of the particle-mixed liquid, which is measured by the temperature sensor.

In an embodiment, the stirring part may include: a stirring driving shaft rotated by the stirring part; a disk-shaped stirring transmission part connected to one end of the stirring driving shaft and rotated in accordance with rotation of the stirring driving shaft, the stirring transmission part having a diameter greater than that of the stirring driving shaft; and a stirring member spaced apart from the stirring driving shaft along a radial direction of the stirring driving shaft and extending from the stirring transmission part toward a bottom surface of the accommodation vessel.

In an embodiment, the stirring member may include: a stirring shaft connected to the stirring transmission part; a first blade portion and a second blade portion coupled at different positions on the stirring shaft to generate flow in the particle-mixed liquid; and a connection portion configured to connect one end of the first blade portion and one end of the second blade portion.

In an embodiment, the rotating part may include: a rotation driving shaft rotated by the rotation driving part; a disk-shaped rotation transmission part connected to one end of the rotation driving shaft and rotated in accordance with rotation of the rotation driving shaft, the rotation transmission part having a diameter greater than that of the rotation driving shaft; and a rotating member spaced apart from the rotation driving shaft along a radial direction of the rotation driving shaft and extending from the rotation transmission part toward the inlet, so as to prevent interference with the stirring member along a circumferential direction of the rotation driving shaft. Here, the ultrasonic generating part may generate the ultrasonic waves from the rotating member toward the stirring member or toward an inner surface of the accommodation vessel.

In an embodiment, the stirring part may have the same rotational speed as that of the rotating part.

In an embodiment, the mixing apparatus may further include an accommodation cover coupled to the accommodation vessel to close the inlet.

In an embodiment, the mixing apparatus may further include: an air pump configured to regulate pressure in the mixing space; a connection fluid path configured to connect the air pump to the mixing space through the accommodation cover; and an external flow path configured to connect the air pump to the outside.

In an embodiment, the mixing apparatus may further include: a cooling vessel configured to surround the accommodation vessel and form a cooling space between the accommodation vessel and the mixing space; and a cooling device including a first flow path which passes through the cooling vessel to introduce a cooling substance into the cooling space and a second flow path through which the cooling substance is discharged to the outside.

In an embodiment, the mixing apparatus may further include a plurality of embossed portions formed by recessing an inner surface of the accommodation vessel toward the mixing space.

In an embodiment, the cooling device may maintain a temperature of the particle-mixed liquid below a preset allowable temperature.

In an embodiment of the present disclosure, a mixing apparatus includes: an accommodation vessel including an inlet on one surface thereof and having a mixing space configured to accommodate a particle-mixed liquid through the inlet; a rotatable stirring part disposed in the mixing space through the inlet to flow the particle-mixed liquid within the accommodation vessel; a stirring driving part configured to rotate the stirring part; and a plurality of ultrasonic generating parts disposed in the stirring part or in the accommodation vessel, disposed at different heights, and configured to generate ultrasonic waves toward the mixing space. Here, the plurality of ultrasonic generating parts have different upper and lower limits of respective amplitudes or respective frequencies, depending on respective heights at which the plurality of ultrasonic generators are disposed.

### BRIEF DESCRIPTION OF THE DRAWINGS

FIG. 1 is a view illustrating an example of an electrode assembly.

FIG. 2 is a view illustrating an example of a mixing apparatus according to the present disclosure.

FIG. 3 is a view illustrating an example of an arrangement of a stirring member and a rotating member.

FIG. 4 is a view illustrating an example of a stirring member.

FIG. 5 is a view illustrating another example of the mixing apparatus according to the present disclosure.

FIG. 6 is a view illustrating another example of the mixing apparatus according to the present disclosure.

FIG. 7 is a control block diagram of the mixing apparatus according to the present disclosure.

### DETAILED DESCRIPTION

Hereinafter, preferred embodiments of the present disclosure will be described in detail with reference to the accompanying drawings. The configuration of the apparatus or control method described hereinafter is for the purpose of illustrating embodiments of the present disclosure and is not intended to limit the scope of the present disclosure, and like reference numerals used throughout the specification refer to like components.

Certain terms used herein are for convenience of description only and are not intended to limit the embodiments shown.

As used herein, battery, secondary battery, and cell all refer to a battery cell that is equally capable of being charged and discharged. Also, as used herein, a mixing device refers to an electrode active material mixing device for mixing liquid positive electrode active material or negative electrode active material.

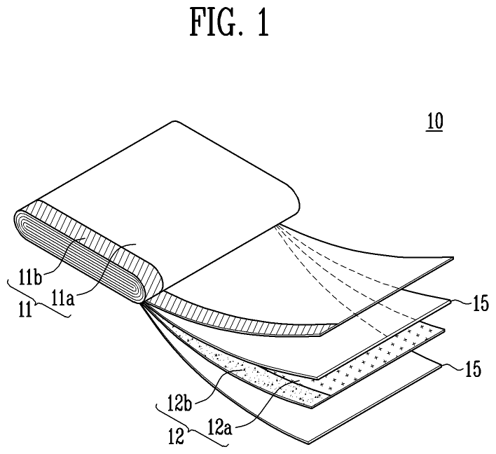

FIG. 1 is a view illustrating an example of an electrode assembly 10.

The electrode assembly 10 may be formed by stacking a first electrode 11, a second electrode 12, and a separator 15 electrically separating the first electrode 11 and the second electrode 12 from each other. The electrode assembly 10 may be immersed in an electrolyte solution inside a casing (not shown) to produce or store electrical energy.

To this end, the first electrode 11 may include a first electrode plate 11a made of a metal material and having a sheet-like shape, and a first coating portion 11b obtained by coating one area of the first electrode plate 11a with one active material.

The second electrode 12 may include a second electrode plate 12a made of a metal material and having a sheet-like shape, and a second coating portion 12b obtained by coating one area of the second electrode plate 12a with another active material.

The electrode assembly 10 may be configured such that the first electrode 11 and the second electrode 12 are alternately stacked, and the separator 15 is disposed between the first electrode 11 and the second electrode 12.

Alternatively, the electrode assembly 10 may be configured such that a first electrode 11 and a second electrode 12 are alternately disposed between a single zigzag-folded separator 15.

Alternatively, the electrode assembly 10 may be formed by winding a single first electrode 11, a single second electrode 12, and a separator 15 disposed between the single first electrode 11 and the single second electrode 12.

For example, the first electrode 11 may be a positive electrode and the second electrode 12 may be a negative electrode. Also, the one active material may be a positive electrode active material, and the another active material may be a negative electrode active material.

The positive electrode active material may include a lithium-nickel metal oxide. The lithium-nickel metal oxide may further include at least one of cobalt (Co), manganese (Mn), and aluminum (Al).

Alternatively, the positive electrode active material may include lithium-iron phosphate.

The positive electrode active material may further include a coating element or a doping element. For example, elements substantially the same or similar to the above-described auxiliary elements may be used as the coating element or the doping element. For example, among the above-described elements, any one element alone or a combination of two or more elements may be used as the coating element or the doping element.

The coating element or the doping element may be present on a surface of the lithium-nickel metal oxide particles, or may penetrate through the surface of the lithium-nickel metal composite oxide particles and be contained within a bonding structure represented by Chemical Formula 1 or Chemical Formula 1-1.

The positive electrode active material may include a nickel-cobalt-manganese (NCM)-based lithium oxide. In this case, the NCM-based lithium oxide with an increased content of nickel may be used.

Ni may be provided as transition metal associated with the power and capacity of the lithium secondary battery. Thus, by employing a high-Ni composition in the positive electrode active material as described above, a high-capacity positive electrode and a high-capacity lithium secondary battery can be provided.

However, as the content of Ni is increased, the long-term preservation stability, lifetime stability, and side reactions with the electrolyte may be relatively reduced for the positive electrode or secondary battery, and side reactions with the electrolyte may also be increased. However, according to exemplary embodiments, by including Co, electrical conductivity may be maintained, while lifetime stability and capacity retention characteristics may be improved through Mn.

The content of Ni in the NCM-based lithium oxide (e.g., the mole fraction of nickel in the total moles of nickel, cobalt, and manganese) may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the positive electrode active material may include a lithium cobalt oxide active material, a lithium manganese oxide active material, a lithium nickel oxide active material, or a lithium iron phosphate (LFP) active material (e.g., LiFePO₄).

The positive electrode active material may further include a positive electrode binder and a conductive material. Additionally, the positive electrode active material may further include a thickener as necessary. For example, the positive electrode binder may be any one selected from polyvinylidenefluoride (PVDF), vinylidene fluoride-co-hexafluoropropylene copolymer (Poly(vinylidene fluoride-co-hexafluoropropylene), polyacrylonitrile, polymethylmethacrylate, and butadiene rubber, or a combination thereof. Also, for example, a PVDF-based binder may be used as the positive electrode binder.

The conductive material may be added to enhance conductivity of the active material and/or mobility of lithium ions or electrons. For example, the conductive material may include a carbon-based conductive material such as graphite, carbon black, acetylene black, quetzene black, graphene, carbon nanotubes (CNTs), vapor-grown carbon fiber (VGCF), and carbon fiber and/or a metal-based conductive material such as tin, tin oxide, titanium oxide, LaSrCoO3, LaSrMnO3, and perovskite materials. However, the embodiment of the present disclosure is not limited thereto.

As necessary, the positive electrode active material may further include a thickener and/or a dispersant. For example, the positive electrode active material may include a thickener such as carboxymethyl cellulose (CMC).

The negative electrode active material may include a material capable of adsorbing and desorbing lithium ions. For example, the negative electrode active material may include a carbon-based material such as crystalline carbon, amorphous carbon, carbon composite, and carbon fiber; a lithium metal; a lithium alloy; a silicon (Si)-containing material or a tin (Sn)-containing material.

For example, the amorphous carbon may be any one selected from hard carbon, soft carbon, coke, mesocarbon microbead (MCMB), and mesophase pitch-based carbon fiber (MPCF), or a combination thereof.

For example, the crystalline carbon may be any one selected from natural graphite, artificial graphite, graphitized coke, graphitized MCMB, and graphitized MPCF, or a combination thereof.

The lithium metal may include pure lithium metal or lithium metal having a protective layer formed thereon to suppress dendrite growth. In one embodiment, a lithium metal-containing layer deposited or coated on the second electrode plate 12a may be used as the negative electrode active material, i.e., a lithium thin film layer may be used as the negative electrode active material.

The elements included in the lithium alloy may be any one selected from aluminum, zinc, bismuth, cadmium, antimony, silicon, lead, tin, gallium, or indium, or a combination thereof.

The silicon-containing material may provide increased capacity characteristics.

For example, the silicon-containing material may be any one selected from of Si, SiOₓ (0<x<2), metal-doped SiOₓ (0<x<2), and silicon-carbon composites, or a combination thereof. The metal may include lithium and/or magnesium, and the metal doped SiOₓ (0<x<2) may include a metal silicate.

For example, the solvent for the negative electrode active material may be any one selected from water, pure water, deionized water, distilled water, ethanol, isopropanol, methanol, acetone, n-propanol, and t-butanol, or a combination thereof.

Also, the negative electrode active material may further include a binder and may optionally further include a conductive material and a thickener.

In some embodiments, the binder may be a styrene-butadiene rubber (SBR) binder, a carboxymethyl cellulose (CMC) binder, a polyacrylic acid binder, or a poly(3,4-ethylenedioxythiophene (PEDOT)-based binder.

The conductive material may be added to enhance the conductivity of the negative electrode active material and/or the mobility of lithium ions or electrons. For example, the conductive material may include carbon-based materials such as graphite, carbon black, acetylene black, quetzene black, graphene, carbon nanotubes, vapor-grown carbon fiber (VGCF), carbon fiber, and/or metal-based materials such as tin, tin oxide, titanium oxide, LaSrCoO₃, LaSrMnO₃, and perovskite materials. However, the embodiment of the present disclosure is not limited thereto.

Also, for example, the thickener may be carboxymethyl cellulose (CMC).

The positive electrode active material may be prepared in the form of a slurry by mixing the above-described materials and then coated onto the first electrode plate 11a. Similarly, the negative electrode active material may be prepared in the form of a slurry by mixing the above-described materials and then coated on the second electrode plate 12a.

In the present disclosure, the slurry form may refer to a liquid having particles dispersed therein and having a viscous consistency or a liquid containing a mixture of particles. For example, the size of each of the particles may generally be 1000 μm or less, which may vary depending on mixed materials.

Thus, the positive electrode active material and the negative electrode active material need to be uniformly mixed in the form of the slurry. Also, in recent years, more positive electrode active materials and negative electrode active materials are required to increase a production efficiency of the electrode assembly 10. The present disclosure relates to a mixing apparatus 1000 capable of producing the above-described positive electrode active material or negative electrode active material in large quantities and mixing the same uniformly in a short time.

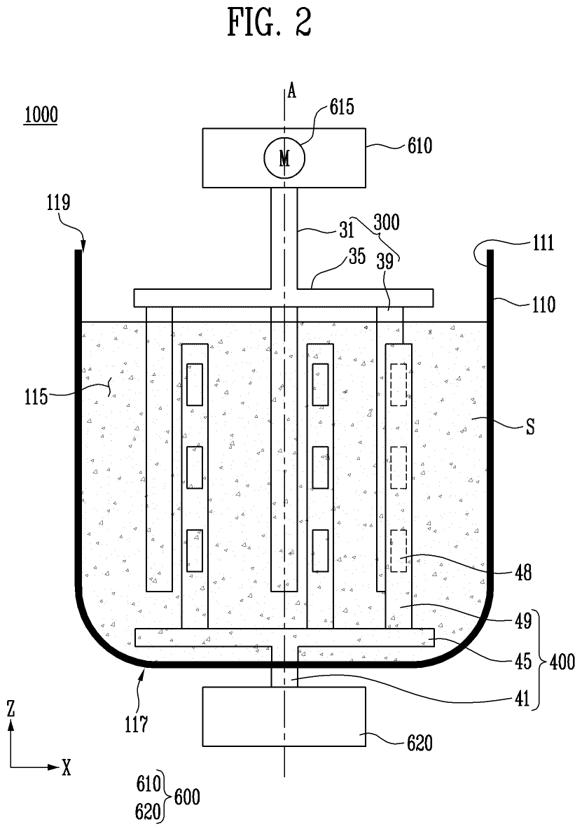

FIG. 2 is a view illustrating an example of a mixing apparatus 1000 according to the present disclosure.

The mixing apparatus 1000 according to the present disclosure includes: an accommodation vessel 110 having an inlet 119 on one surface thereof and having a mixing space 115 for accommodating a particle-mixed liquid through the inlet 119; a rotatable stirring part 300 disposed in the mixing space 115 through the inlet 119 to allow the particle-mixed liquid to flow within the accommodation vessel 110; a stirring driving part 610 for rotating the stirring part 300, a rotating part 400 spaced apart from the stirring part 300 and being rotatable with the stirring part 300 for mixing the particle-mixed liquid within the accommodation vessel 110; a rotation driving part 620 for rotating the rotating part 400; and an ultrasonic generating part 48 disposed in at least one of the stirring part 300 and the accommodation vessel 110 to generate an ultrasonic wave toward the mixing space 115.

The accommodation vessel 110 may have a mixing space 115 therein. The mixing space 115 may accommodate a particle-mixed liquid S. The accommodation vessel 110 may include an inlet 119 at one surface, and the particle-mixed liquid S may be accommodated in the mixing space 115 through the inlet 119.

The accommodation vessel 110 has a large capacity to accommodate the particle-mixed liquid S. The large capacity may represent that a volume of the particle-mixed liquid S accommodated in the accommodation vessel 110 is 2000 L (liters) or more.

The volume of the particle-mixed liquid S may be maintained in a range from 70% to 90% based on a volume of the mixing space 115.

The accommodation vessel 110 may have a bottom surface 117 forming a bottom surface of the mixing space 115. The bottom surface 117 may have a flat shape or may have a shape protruding in a downward direction.

At least a portion of the stirring part 300 may be inserted into the mixing space 115 via the inlet 119. At least a portion of the stirring part 300 may be immersed and rotated in the particle-mixed liquid S. Thus, the stirring part 300 may rotate the particle-mixed liquid S. Thereby, the particles may be uniformly dispersed in the liquid.

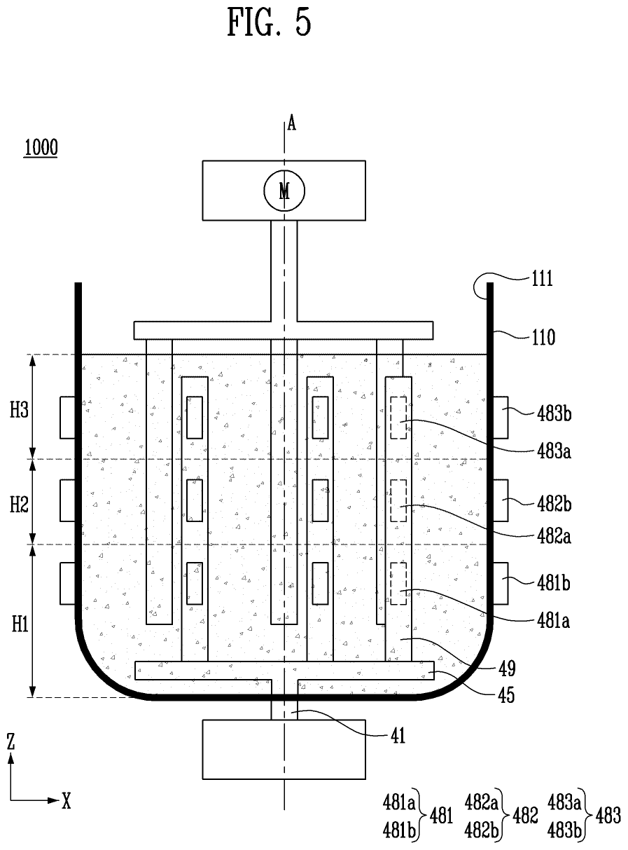

The stirring driving part 610 may transmit a rotational force to the stirring part 300. To this end, the stirring driving part 610 may include a stirring motor 615 that generates a rotational force. In some cases, the stirring driving part 610 may further include a gear or a belt that transmit the rotational force of the stirring motor 615. Although the stirring motor 615 is disposed above the stirring part 300 in FIG. 5, this is merely an example. The stirring motor 615 may be disposed at any location as long as the stirring motor 615 is capable of transmitting a rotational force to the stirring part 300.

More specifically, the stirring part 300 may include a stirring driving shaft 31 rotated by the stirring driving part 610, a disk-shaped stirring transmission part 35 connected to one end of the stirring driving shaft 31 and rotated in accordance with the rotation of the stirring driving shaft 31, and having a diameter greater than that of the stirring driving shaft 31, and a stirring member 39 spaced apart from the stirring driving shaft 31 along a radial direction of the stirring driving shaft 31 and extending from the stirring transmission part 35 toward the bottom surface of the accommodation vessel 110.

The stirring member 39 may extend along an axial direction of the stirring driving shaft 31.

Referring to FIG. 2, the stirring member 39 may be disposed on the stirring transmission part 35 within a predetermined radius about the stirring driving shaft 31. Also, the stirring member 39 may be provided in plurality.

The stirring member 39 may be rotated with the stirring driving shaft 31 as the stirring transmission part 35 is rotated in accordance with the rotation of the stirring driving shaft 31. Alternatively, the stirring member 39 may be rotated independently of the stirring driving shaft 31.

The rotating part 400 may be spaced apart from the stirring part 300 while facing the stirring part 300. At least a portion of the rotating part 400 may be immersed in the particle-mixed liquid S and rotated with the stirring part 300 in accordance with the rotation of the stirring part 300. Also, the stirring part 300 may have the same rotational speed as that of the rotating part 400 to prevent interference between the stirring part 300 and the rotating part 400.

For example, the rotational speed of the stirring part 300 may be equal to or greater than 50 RPM (revolutions per minute) and equal to or less than 300 RPM.

As with the stirring part 300, the rotating part 400 may rotate the particle-mixed liquid S. To this end, the rotating part 400 may penetrate the bottom surface 117, and at least a portion of the rotating part 400 may be inserted into the mixing space 115, i.e. at least a portion of the rotating part 400 may be immersed in the particle-mixed liquid S.

The rotation driving part 620 may transmit a rotational force to the rotating part 400. To this end, the rotation driving part 620 may include a rotary motor (not shown) that generates a rotational force. In some cases, the rotation driving part 620 may further include a gear or a belt that transmits a rotational force of the rotary motor.

More specifically, the rotating part 400 may include a rotation driving shaft 41 rotated by the rotation driving part 620, a disk-shaped rotation transmission part 45 connected to one end of the rotation driving shaft 41 and rotated in accordance with the rotation of the rotation driving shaft 41, and having a diameter greater than that of the rotation driving shaft 41, and a rotating member 49 spaced apart from the rotation driving shaft 41 along a radial direction of the rotation driving shaft 41 and extending from the rotation driving shaft 45 toward the inlet 119 to prevent interference with the stirring member 39 along a circumferential direction of the rotation driving shaft 41.

The stirring driving shaft 31, a central axis A of the accommodation vessel 110, and the rotation driving shaft 41 may share the same axial direction.

On the other hand, the stirring driving shaft 610 and the rotation driving shaft 620 may be collectively referred to as a driving part 600. The driving part 600 may rotate the stirring part 300 and the rotating part 400.

Although the rotary motor (not shown) is disposed above the rotating part 400 in FIG. 2, this is merely an example. The rotary motor (not shown) may be disposed at any location as long as the rotary motor (not shown) is capable of transmitting a rotational force to the rotation part 400. Alternatively, the stirring part 300 and the rotating part 400 may be rotated at the same speed to prevent interference therebetween. To this end, instead of the rotary motor, the stirring motor 615 may transmit a rotational force to the stirring part 300 and the rotating part 400 simultaneously.

The ultrasonic generating part 48 may apply ultrasonic waves to the particle-mixed liquid S. In the present disclosure, an ultrasonic wave refers to sound pressure having a frequency above the upper audible limit range of human hearing. This upper audible limit range varies from person to person, but is generally about 20 kHz (kilohertz). Thus, the ultrasonic wave refers to an acoustic wave having a frequency of 20 kHz or higher.

For example, the frequency of the ultrasonic wave generated by the ultrasonic generating part 48 may be equal to or greater than 20 kHz and equal to or less than 60 kHz. Also, the power intensity of the ultrasonic wave generated by the ultrasonic generating part 48 may be equal to or greater than 100 W/cm² (watts per square centimeter) and equal to or less than 200 W/cm².

The ultrasonic generating part 48 may be disposed at any location that allows the ultrasonic wave to be applied to the particle-mixed liquid S.

For example, the ultrasonic generating part 48 may be disposed on the rotating part 400. The ultrasonic generating part 48 may protrude outwardly from the rotating part 400 or may be inserted into the rotating part 400.

Also, the ultrasonic generating part 48 may generate the ultrasonic waves from the rotating member 49 toward the stirring part 39 or toward an inner surface of the accommodation vessel 110. This allows the ultrasonic generating part 48 to radiate the ultrasonic waves uniformly in the mixing space 115.

Alternatively, the ultrasonic generating part 48 may be disposed in the accommodation vessel 110. For example, the ultrasonic generating part 48 may be disposed on the inner surface 111 of the accommodation vessel 110 having the bottom surface 117 or disposed on an outer surface of the accommodation vessel 110.

The mixing apparatus 1000 according to the present disclosure may not include the separated rotating part 400 and the separated rotating driving part 620. In this case, the ultrasonic generating part 48 may be disposed in the stirring part 300 or in the accommodation vessel 110.

In other words, the ultrasonic generating part 48 may be disposed in the stirring part 300. The ultrasonic generating part 48 may protrude outward from the stirring part 300 or may be inserted into the stirring part 300.

Alternatively, the ultrasonic generating part 48 may be disposed in the accommodation vessel 110. The ultrasonic generating part 48 may be disposed on the inner surface 111 of the accommodation vessel 110, which forms an inner surface of the mixing space 115, or may be disposed on the outer surface of the accommodation vessel 110.

On the other hand, the ultrasonic generating part 48 may generate pulsed ultrasonic waves. The pulsed wave represents a rectangular waveform repeated at a predetermined interval.

In other words, the mixing apparatus 1000 according to the present disclosure may include: an accommodation vessel 110 having an inlet 119 on one surface thereof and having a mixing space 115 for accommodating a particle-mixed liquid S through the inlet 119; a rotatable stirring part 300 disposed in the mixing space 115 through the inlet 119 to allow the particle-mixed liquid S to flow within the accommodation vessel 110; a stirring driving part 610 for rotating the stirring part 300; and a plurality of ultrasonic generating parts 48 disposed in at least one of the stirring part 300 and the accommodation vessel 110, disposed at different heights, and generating pulsed ultrasonic waves toward the mixing space 115.

In other words, whereas the stirring part 300 may use physical stirring to uniformly stir the particle-mixed liquid S, the ultrasonic generating part 48 may use ultrasonic waves to stir the particle-mixed liquid S.

For example, the pulsed ultrasonic wave may have a frequency of 20 kHz or more and 60 kHz or less, a duty cycle of 10% or more and 90% or less, a pulse interval of the pulsed ultrasonic wave of 1 second or more and 10 seconds or less, and a pulse duration of 0.5 seconds or more and 5 seconds or less per pulse.

Also, the power density of the ultrasonic wave may be equal to or greater than 10 W/cm² (watts per square centimeter) and equal to or less than 50 W/cm². The frequency, power density, and shape of the pulses of the ultrasonic waves may be variable depending on the properties of the particle-mixed liquid S (e.g., temperature, viscosity at the time of stirring, or sizes of the mixed particles).

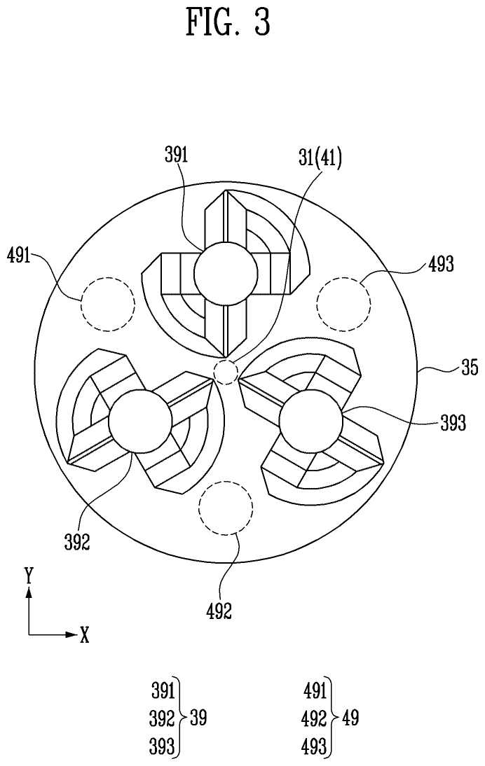

FIG. 3 is a view illustrating an example of an arrangement state of the stirring member 39 and the rotating member 49.

FIG. 3 illustrates an example of the stirring member 39 viewed from the rotating member 49, and also schematically illustrates schematic positions of the stirring driving shaft 31 and the rotating member 49 on the stirring transmission part 35.

Referring to FIG. 3, the stirring transmission part 35 may have a shape of a disk centered on the stirring driving shaft 31. The rotating member 49 may be disposed on one surface of the stirring transmission part 35 along a circumferential direction of the stirring driving shaft 31. A radius from the stirring driving shaft 31 to the rotating member 49 may be greater than that of the stirring driving shaft 31. This allows the particle-mixed liquid S to be more efficiently mixed over a larger area.

Each of the stirring member 39 and the rotating member 49 may be provided in plurality. For example, the stirring member 39 may include a first stirring member 391, a second stirring member 392, and a third stirring member 393. Similarly, the rotating member 49 may include a first rotating member 491, a second rotating member 492, and a third rotating member 493.

Since rotation of the stirring part 300 requires rotation of the rotating part 400, it is necessary for the stirring part 39 and the rotating part 49 to prevent interference with each other. To this end, the plurality of rotating members 49 may be arranged between the plurality of stirring members 39 along the circumferential direction of the stirring driving shaft 31.

Alternatively, a radius from the stirring driving shaft 31 to the plurality of stirring members 39 may be different from that from the stirring driving shaft 31 to the plurality of rotating members 49 to avoid interference.

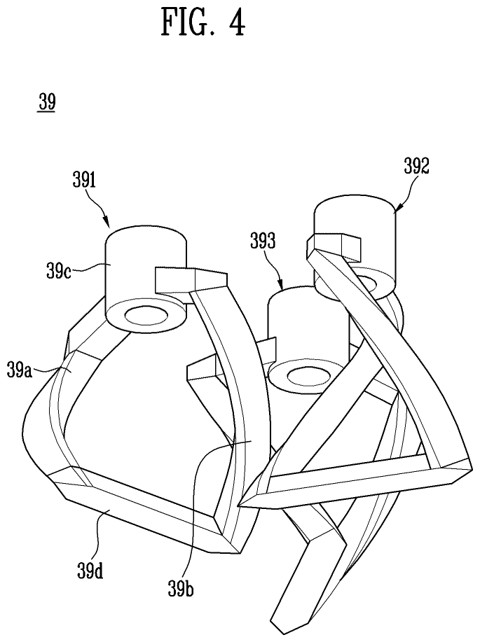

FIG. 4 is a view illustrating an example of the stirring member 39.

In order to effectively stir the particle-mixed liquid S, the stirring member 39 may include a stirring shaft 39d connected to the stirring transmission part 35, a first blade portion 39a and a second blade portion 39b coupled at different positions on the stirring shaft 39d to generate flow in the particle-mixed liquid, and a connection portion 39c connecting a first end of the first blade portion 39a to a second end of the second blade portion 39b.

The stirring member 39 may be provided in plurality. Each of the plurality of stirring members 39 may include the first blade portion 39a, the second blade portion 39b, and the connection portion 39c.

The first blade portion 39a and the second blade portion 39b may be curved along a direction from the inlet 119 toward the bottom surface 117, and may have a skewed shape.

For active or independent rotation of the stirring member 39, the stirring axis 39d may be coupled to the stirring transmission part 35 so as to be rotated about the stirring axis 39d. Although the stirring shaft 39d is actively or independently rotated, the stirring transmission part 35 may be rotated by rotation of the stirring driving shaft 31.

Alternatively, the stirring member 39 may be only rotated about the stirring axis 39d passively by rotation of the stirring transmission part 35.

The first blade portion 39a and the second blade portion 39b of any one of the first stirring member 391, the second stirring member 392, and the third stirring member 393 may be arranged so as not to interfere with the first blade portion 39a and the second blade portion 39b of an adjacent other stirring member 39.

For example, respective first blade portions 39a and respective second blade portions 39b of the first stirring member 391, the second stirring member 392, and the third stirring member 393 may be arranged so as not to interfere with each other.

Hereinafter, portions that are redundant to the description of FIGS. 1 through 4 are omitted.

FIG. 5 is a view illustrating another example of the mixing apparatus 1000 according to the present disclosure.

Referring to FIG. 5, the mixing apparatus 1000 according to the present disclosure includes an accommodation vessel 110 having an inlet 119 on one surface thereof and having a mixing space 115 for accommodating a particle-mixed liquid S through the inlet 119; a rotatable stirring part 300 disposed in the mixing space 115 through the inlet 119 to allow the particle-mixed liquid S to flow within the accommodation vessel 110; a stirring driving part 610 for rotating the stirring part 300; and a plurality of ultrasonic generating parts 48 disposed in at least one of the stirring part 300 and the accommodation vessel 110, disposed at different heights, and generating ultrasonic waves toward the mixing space 115.

Also, the plurality of ultrasonic generating parts 48 may have different upper and lower limits of each amplitude or each frequency of the plurality of ultrasonic generating parts 48, depending on the respective heights at which the plurality of ultrasonic generators 48 are disposed.

In other words, the ultrasonic generating part 48 may be provided in a plurality, the plurality of ultrasonic generating parts 48 may be disposed at different heights relative to the lowest limit of the accommodation vessel 110, and the plurality of ultrasonic generating parts 48 may each generate ultrasonic waves having upper and lower limits of different amplitudes or different frequency upper depending on heights at which the ultrasonic generating parts 48 are disposed.

For example, referring to FIG. 5, the plurality of ultrasonic generating parts 48 may include a first ultrasonic generating part 481 disposed in a first region from a lowest limit to a predetermined first height H1 of the accommodation vessel 110, a second ultrasonic generating part 482 disposed in a second region from the first height H1 to a predetermined second height H2, and a third ultrasonic generating part 483 disposed in a third region from the second height H2 to the inlet 119 (or to a preset third height H3). Here, the upper and lower limits of the amplitude or frequency of each ultrasonic wave generated by the first ultrasonic generating part 481, the second ultrasonic generating part 482, and the third ultrasonic generating part 483 may be different.

In other words, the first ultrasonic generating part 481 may be disposed in at least one of the accommodation vessel 110, the rotating member 49, and the stirring member 39 in the first region. The second ultrasonic generating part 482 may be disposed in at least one of the accommodation vessel 110, the rotating member 49, and the stirring member 39 in the second region. The third ultrasonic generating part 483 may be disposed in at least one of the accommodation vessel 110, the rotating member 49, and the stirring member 39 in the third region.

Also, as described above, the first ultrasonic generating part 481, the second ultrasonic generating part 482, and the third ultrasonic generating part 483 may have different power densities or different amplitudes.

Also, the first ultrasonic generator 481, the second ultrasonic generator 482, and the third ultrasonic generator 483 may have different upper and lower frequency limits.

For example, the first ultrasonic generator 481 may be disposed in the first region (e.g., the bottom surface 117) to apply ultrasonic waves to the particle-mixed liquid S. The frequency of the first ultrasonic generator 481 may be equal to or greater than 20 kHz (kilohertz) and equal to or less than 40 kHz.

Also, the output power of the first ultrasonic generator 481 may be 150 W/cm². This enables the first ultrasonic generator 481 to apply ultrasonic waves to the liquid S in which particles disposed in the first region and having relatively high viscosity are mixed.

More specifically, referring to FIG. 5, the first ultrasonic generating part 481 may include at least one of a first axial acoustic part 481a disposed on the rotating member 49 and a first vessel acoustic part 481b disposed on the accommodation vessel 110.

The second ultrasonic generating part 482 may be disposed in the second region (e.g., a second region of the rotating member 49) to ensure that the energy transmitted by the ultrasonic waves is uniformly distributed when the particle-mixed liquid S flows. For example, the second ultrasonic generating part 482 may have a frequency equal to or greater than 30 kHz (kilohertz) and equal to or less than 60 kHz.

Also, the output power of the second ultrasonic generator 482 may be 100 W/cm².

More specifically, referring to FIG. 5, the second ultrasonic generating part 482 may include at least one of a second axial acoustic part 482a disposed on the rotating member 49 and a second vessel acoustic part 482b disposed on the accommodation vessel 110.

The third ultrasonic generating part 483 may be disposed in the third region (e.g., a third region of the rotating member 49) to apply pulsed ultrasonic waves to the particle-mixed liquid S. This is to prevent damage to the particle-mixed liquid S and to maximize the mixing effect by increasing the temperature of the particle-mixed liquid S due to the ultrasonic waves applied to the particle-mixed liquid S from the ultrasonic generating part 48.

For example, the pulsed ultrasonic waves generated by the third ultrasonic generating part 483 may have a pulse interval of 5 seconds, a pulse duration of 2 seconds, and a duty cycle of 50%.

More specifically, referring to FIG. 5, the third ultrasonic generating part 483 may include at least one of a third axial acoustic part 483a disposed on the rotating member 49 and a third vessel acoustic part 483b disposed on the accommodation vessel 110.

On the other hand, the ultrasonic generating part 48 may generate the ultrasonic waves intermittently with the rotation of the stirring part 300, i.e., even though the stirring part 300 and the rotating part 400 rotate together, the time for generating the ultrasonic waves in the ultrasonic generating part 48 may be less than the rotation time of the stirring part 300. This is to prevent the temperature of the particle-mixed liquid S from rising rapidly due to the ultrasonic generating part 48.

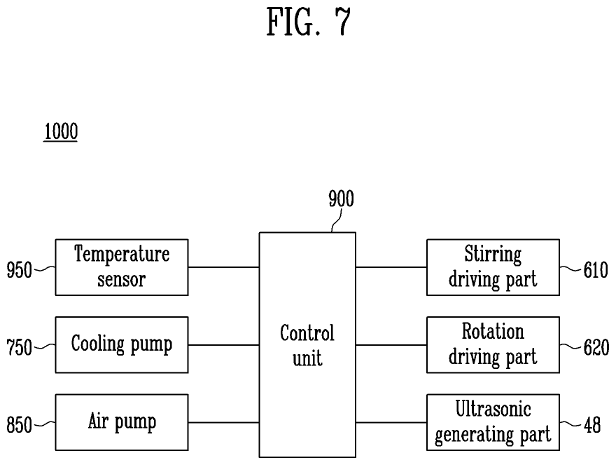

In order to check the temperature of the particle-mixed liquid S, the mixing apparatus 1000 according to the present disclosure may further include a temperature sensor 950 (refer to FIG. 7) for measuring the temperature of the particle-mixed liquid.

Thus, the ultrasonic generating part 48 may repeat the generation and interruption of the ultrasonic waves based on the temperature of the particle-mixed liquid, which is measured by the temperature sensor 950.

The temperature sensor 950 may use a contact or non-contact method, as long as the temperature of the particle-mixed liquid S may be checked, and the temperature sensor 950 may likewise be disposed at any location as long as the temperature of the particle-mixed liquid S may be checked.

For example, the ultrasonic generating part 48 may stop generating ultrasonic waves when the temperature of the particle-mixed liquid exceeds a preset allowable temperature. Also, the rotational speed and rotation time of the stirring part 300 may be variable based on the temperature of the particle-mixed liquid, which is measured by the temperature sensor 950.

The rotation time or rotation speed of the stirring part 300, and the ultrasonic generation time of the ultrasonic generating part 48 may depend not only on the temperature, but also on the size of the particles and the viscosity of the particle-mixed liquid S.

For example, as the size of the particles increases, the rotation time of the stirring part 300 and the ultrasonic generation time may relatively increase. This is because it takes relatively longer to uniformly suspend the particles in the liquid due to the size of the particles.

For example, the greater the viscosity of the particle-mixed liquid S, the greater the rotation time of the stirring part 300 and the ultrasonic generation time may be relatively increased.

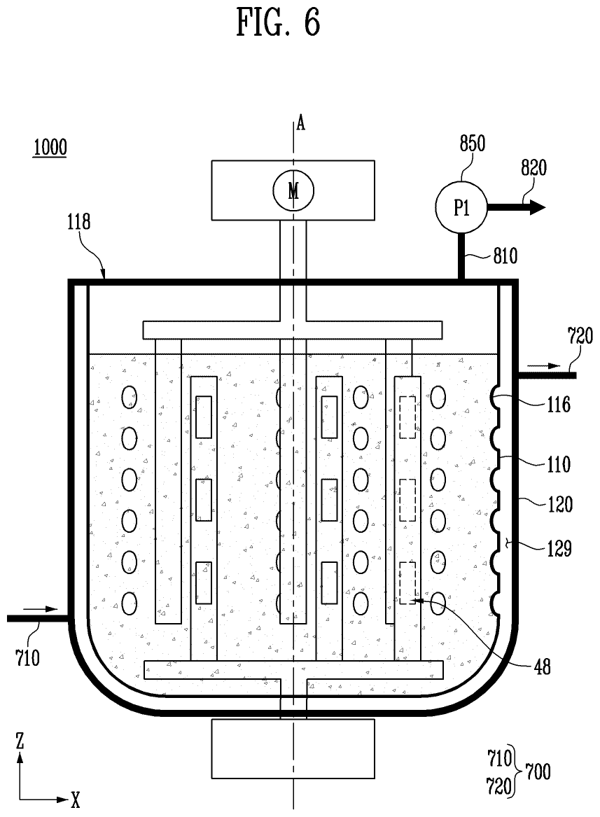

FIG. 6 is a view illustrating another example of the mixing apparatus 1000 according to the present disclosure.

The mixing apparatus 1000 according to the present disclosure may further include an accommodation cover 118, which is coupled to the accommodation vessel 110 and closes the inlet 119. This is to regulate the pressure in the mixing space 115.

To this end, the mixing apparatus 1000 according to the present disclosure may further include an air pump 850 for regulating the pressure in the mixing space 115, a connection fluid path 810 connecting the air pump 850 to the mixing space 115 through the accommodation cover, and an external fluid path 820 connecting the air pump 850 to the outside.

For example, the air pump 850 may be a pressurized pump, i.e., the air pump 850 may maintain the pressure in the mixing space 115 at a pressure above external atmospheric pressure (e.g., at least 1 bar and no more than 5 bar). This is to optimize the ultrasonic waves generated by the ultrasonic generating part 48 as the waves cause cavitation.

The air pump 850 may suction air via the external flow path 820, pressurize the suctioned air, and supply the air to the mixing space 115 via the connecting flow path 810.

Alternatively, the air pump 850 may be a vacuum pump. The ultrasonic waves generated by the ultrasonic generating part 48 are intended to effectively remove the air bubbles generated when the cavitation occurs.

In other words, the air pump 850 may maintain the pressure in the mixing space 115 at a pressure lower than the external atmospheric pressure. The operation of the air pump 850 may be performed during the operation of the stirring part 300 or the ultrasonic generating part 48 or after the operation of the stirring part 300 or the ultrasonic generating part 48 is ended.

On the other hand, in order to manage the temperature of the particle-mixed liquid S due to the ultrasonic waves, the mixing apparatus 1000 according to the present disclosure may further include: a cooling vessel 120 surrounding the accommodation vessel 110 and forming a cooling space 129 between the accommodation vessel 110 and the cooling vessel 120; and a cooling device 700 including a first flow path 710 which passes through the cooling vessel 120 and through which a cooling substance is input into the cooling space 129 and a second flow path 720 through which the cooling substance is discharged to the outside.

For circulation of the cooling substance, the cooling device 700 may further include a cooling pump 750 (refer to FIG. 7) for supplying the cooling substance to the first flow path 710.

Although an example of the mixing apparatus 1000 including the vessel having double walls is illustrated in FIG. 5, the cooling device 700 may be a pipe coiled around the outer surface of the accommodation vessel 110, unlike the mixing apparatus 1000.

Also, the mixing apparatus 1000 according to the present disclosure may further include a plurality of embossed portions 116 formed by recessing the inner surface of the accommodation vessel 110 toward the mixing space 115. This is to increase the area of the inner surface 111 of the vessel in which heat exchange between the cooling substance and the particle-mixed liquid S occurs.

Alternatively, the mixing apparatus 1000 may include fins for heat-exchange, formed by the inner surface 111 protruding towards the mixing space 115 or by an outer surface of the accommodation vessel 110 protruding towards the cooling space 129.

Through this, the cooling device 700 may maintain the temperature of the particle-mixed liquid below a predetermined allowable temperature. For example, the allowable temperature may be 200° C.) (degrees Celsius).

FIG. 7 is a control block diagram of the mixing apparatus 1000 according to the present disclosure.

The mixing apparatus 1000 according to the present disclosure may include a control unit 900 that controls the stirring driving part 610 and the ultrasonic generator part 48.

Also, the control unit 900 may control the rotation driving part 620 and the temperature sensor 950. In addition, the control unit 900 may control operations of the air pump 850 and the cooling pump 750.

According to one embodiment of the present disclosure, the manufacturing efficiency of the battery cells may be improved.

According to another embodiment of the present disclosure, the positive electrode active material or the negative electrode active material may be uniformly mixed in the large capacity mixing apparatus in a short time.

According to another embodiment of the present disclosure, ultrasonic waves may be utilized to uniformly mix the positive electrode active material or the negative electrode active material.

According to another embodiment of the present disclosure, the temperature of the liquid active material accommodated in the mixing apparatus may be prevented from rising excessively while utilizing ultrasonic waves.

According to another embodiment of the present disclosure, the materials mixed in the mixing apparatus may be prevented from being damaged during the mixing process.

According to another embodiment of the present disclosure, it is possible to minimize the inclusion of air bubbles in the positive electrode active material or the negative electrode active material while utilizing the ultrasonic waves.

The present disclosure may be modified in various forms, and thus the scope of the present disclosure is not limited to the above-described embodiments. Therefore, if the modified embodiment includes the components of the claims of this disclosure, it should be considered to fall within the scope of the claims of this disclosure.

What is claimed is:

1. A mixing apparatus comprising:
an accommodation vessel comprising an inlet on one surface thereof and having a mixing space configured to accommodate a particle-mixed liquid through the inlet;
a rotatable stirring part disposed in the mixing space through the inlet to allow the particle-mixed liquid to flow within the accommodation vessel;
a stirring driving part configured to rotate the stirring part;
a rotating part spaced apart from the stirring part and rotated with the stirring part to rotate the particle-mixed liquid within the accommodation vessel;
a rotation driving part configured to rotate the rotating part; and
an ultrasonic generating part disposed in at least one of the rotating part, the stirring part, or the accommodation vessel to generate ultrasonic waves toward the mixing space.

2. The mixing apparatus of claim 1, wherein the ultrasonic generation part generates pulsed ultrasonic waves.

3. The mixing apparatus of claim 1, wherein the ultrasonic generating part is provided in plurality,
the plurality of ultrasonic generating parts are disposed at different heights based on a lowest limit of the accommodation vessel, and
the plurality of ultrasonic generating parts have respective upper and lower limits of different amplitudes or different frequencies, depending on heights at which the plurality of ultrasonic generating parts are disposed.

4. The mixing apparatus of claim 3, wherein the plurality of ultrasonic generating parts comprise:
a first ultrasonic generating part disposed in a first region from the lowest limit of the accommodation vessel to a preset first height;
a second ultrasonic generating part disposed in a second region from the first height to a preset second height; and
a third ultrasonic generator disposed in a third region from the second height to the inlet,
wherein amplitudes or frequencies of respective ultrasonic waves generated by the first ultrasonic generating part, the second ultrasonic generating part, and the third ultrasonic generating part have different upper and lower limits.

5. The mixing apparatus of claim 1, wherein the ultrasonic generating part generates the ultrasonic waves intermittently when the stirring part is rotated.

6. The mixing apparatus of claim 1, further comprising a temperature sensor configured to measure a temperature of the particle-mixed liquid.

7. The mixing apparatus of claim 6, wherein the ultrasonic generating part repeatedly generates and stops generating the ultrasonic waves based on the temperature of the particle-mixed liquid, which is measured by the temperature sensor.

8. The mixing apparatus of claim 7, wherein the ultrasonic generating part stops generating the ultrasonic waves when the temperature of the particle-mixed liquid exceeds a preset allowable temperature.

9. The mixing apparatus of claim 7, wherein the rotational speed and rotational time of the stirring part are variable based on the temperature of the particle-mixed liquid, which is measured by the temperature sensor.

10. The mixing apparatus of claim 1, wherein the stirring part comprises:
a stirring driving shaft rotated by the stirring driving part;
a disk-shaped stirring transmission part connected to one end of the stirring driving shaft and rotated in accordance with rotation of the stirring driving shaft, the stirring transmission part having a diameter greater than that of the stirring driving shaft; and
a stirring member spaced apart from the stirring driving shaft along a radial direction of the stirring driving shaft and extending from the stirring transmission part toward a bottom surface of the accommodation vessel.

11. The mixing apparatus of claim 10, wherein the stirring member comprises:
a stirring shaft connected to the stirring transmission part;
a first blade portion and a second blade portion coupled at different positions on the stirring shaft to generate flow in the particle-mixed liquid; and
a connection portion configured to connect one end of the first blade portion to one end of the second blade portion.

12. The mixing apparatus of claim 10, wherein the rotating part comprises:
a rotation driving shaft rotated by the rotation driving part;
a disk-shaped rotation transmission part connected to one end of the rotation driving shaft and rotated in accordance with rotation of the rotation driving shaft, the rotation transmission part having a diameter greater than that of the rotation driving shaft; and
a rotating member spaced apart from the rotation driving shaft along a radial direction of the rotation driving shaft and extending from the rotation transmission part toward the inlet, so as to prevent interference with the stirring member along a circumferential direction of the rotation driving shaft,
wherein the ultrasonic generating part generates the ultrasonic waves from the rotating member toward the stirring member or toward an inner surface of the accommodation vessel.

13. The mixing device of claim 1, wherein the stirring part has the same rotational speed as that of the rotating part.

14. The mixing apparatus of claim 1, further comprising an accommodation cover coupled to the accommodation vessel to close the inlet.

15. The mixing apparatus of claim 14, further comprising:
an air pump configured to regulate pressure in the mixing space;
a connection fluid path configured to connect the air pump to the mixing space through the accommodation cover; and
an external flow path configured to connect the air pump to the outside.

16. The mixing apparatus of claim 1, further comprising:
a cooling vessel configured to surround the accommodation vessel and form a cooling space between the accommodation vessel and the mixing space; and
a cooling device comprising a first flow path which passes through the cooling vessel to introduce a cooling substance into the cooling space and a second flow path through which the cooling substance is discharged to the outside.

17. The mixing apparatus of claim 16, further comprising a plurality of embossed portions formed by recessing an inner surface of the accommodation vessel toward the mixing space.

18. The mixing apparatus of claim 16, wherein the cooling device maintains a temperature of the particle-mixed liquid below a preset allowable temperature.

19. A mixing apparatus comprising:
an accommodation vessel comprising an inlet on one surface thereof and having a mixing space configured to accommodate a particle-mixed liquid through the inlet;
a rotatable stirring part disposed in the mixing space through the inlet to flow the particle-mixed liquid within the accommodation vessel;
a stirring driving part configured to rotate the stirring part; and
a plurality of ultrasonic generating parts disposed in the stirring part or in the accommodation vessel, disposed at different heights, and configured to generate ultrasonic waves toward the mixing space,
wherein the plurality of ultrasonic generating parts have different upper and lower limits of respective amplitudes or respective frequencies, depending on respective heights at which the plurality of ultrasonic generators are disposed.

20. A mixing apparatus comprising:
an accommodation vessel comprising an inlet on one surface thereof and having a mixing space configured to accommodate a particle-mixed liquid through the inlet;
a rotatable stirring part disposed in the mixing space through the inlet to allow the particle-mixed liquid to flow within the accommodation vessel;
a stirring driving part configured to rotate the stirring part; and
a plurality of ultrasonic generating parts disposed in the stirring part or in the accommodation vessel, disposed at different heights, and configured to generate pulsed ultrasonic waves towards the mixing space.
